(19) United States
(12) Patent Application Publication
(10) Pub. No.: US 2009/0083482 A1
(43) Pub. Date: Mar. 26, 2009

(54) Increasing the speed at which flash memory is written and read

(75) Inventors: William Pat Price, Rhome, TX (US); Timothy J. Elliott, Huntington Beach, CA (US)

Correspondence Address: Law Office of Scott C Harris Inc, PO Box 1389, Rancho Santa Fe, CA, 92067, US

(73) Assignee: VIZIO, Irvine, CA (US)

(21) Appl. No.: 11/859,686

(22) Filed: Sep. 21, 2007

(51) Int. Cl. G06F 13/00

(52) U.S. Cl. 711/114; 711/E12.021

(57) ABSTRACT

Flash memory often cannot be written at speeds approaching those of rotating magnetic storage speeds. This embodiment permits normal NAND flash to be written much faster and to be read at speeds exceeding typical speeds and through put for normal hard disk storage and enables these speeds while removing incremental cost from the device packaging.

### BACKGROUND

Advances in flash memory have enabled the creation of small mobile devices by providing a relatively inexpensive way to store data. This technology provides the storage capability of personal handheld music and video players, PDAs, and new classes of sub notebook size portable computers.

Flash memory devices provide quick access to data for read applications. These devices, in fact, often outperform hard disk drives which have latency built in because of the rotating media. Flash memory, however, can be very slow when writing data. Hard disk drives often have write throughput speeds exceeding several gigabytes per minute. Flash memory write throughputs are often measured in tens of megabytes per minute. Because of this limitation, flash memory has not made inroads into applications that require prolonged sustained write operations such as audio or video recording where the content being recorded is massive in size.

U.S. Pat. Nos. 7,155,560; 7,062,616; 6,836,816; 6,748,482; 6,704,835; 6,418,506; and 5,680,579 address issues with flash memory.

Techniques have attempted to address the slow write speeds of flash memory. These approaches have focused on providing a DRAM or SRAM cache that holds or queues data that is to be written to the flash memory module. Some of these approaches place the cache memory on circuit assemblies that are coupled between the flash memory module and the data bus. Others place the cache inside the flash memory chip itself. All of the cache approaches fail to improve long sustained write operations

U.S. Pat. No. 5,680,579 attempts to solve the slow write throughput problem by ganging flash memory modules onto multiple circuit cards and placing the memory assemblies and a RAID controller assemble into a common enclosure. This approach certainly improves the write throughput but may add large amounts of cost. This approach only works well in mission critical applications where the cost of the solution takes second place to the criticality of the mission.

### SUMMARY

An aspect of the disclosure couples flash memory's strong suites (superior tolerance to physical shock and low power consumption while idle) and at the same time improves write throughput.

An advantage of this system is that, for certain applications, flash memory can displace HDDs. Aspects address high sustained write throughputs and at the same time preserve cost targets for manufacturing inexpensive flash memory products.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 depicts an embodiment where flash memory and the control electronics including the flash memory controllers reside on separate circuit assemblies.

FIG. 2 depicts an embodiment using flash memory chips that do not require separate flash memory controllers.

FIG. 3 depicts a typical USB flash drive with its major components.

### DETAILED DESCRIPTION

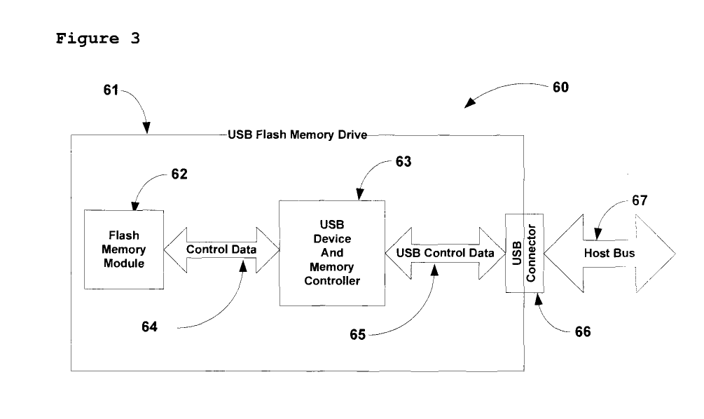

FIG. 3 illustrates a USB flash drive assembly 60. USB Flash Memory Drive (61) has a USB connector (66), USB Device and Memory Controller (63) and Flash Memory Module (62). When a host system writes data to USB Flash Memory Drive (61), commands, control, and data are sent to USB Flash Memory Drive (61) from the Host Bus (67) to USB connector (66). Device internal bus (65) carries the signals (commands, control, and data) from USB Connector (66) to USB Device and Memory Controller (63). USB Device and Memory Controller (63) communicates with Flash Memory Module (62) through bus (64) and sends data and write commands to Flash Memory Module (62).

When a host system reads data from USB Flash Memory Drive (61), the host sends a command to USB Flash Memory Drive (61) via USB connector (66). The command is received from USB Connector (66) to USB Device and Memory Controller (63). USB Device and Memory Controller (63) processes the command and sends control signals and address information to Flash Memory Module (62) across bus (64). Flash Memory Module (62) transfers the requested data over bus (64) to USB Device and Memory Controller (63). USB Device and Memory Controller (63) then send the data across internal bus (65) to USB Connector (66) and to the host via Host Bus (67).

Notice that in FIG. 3 USB Flash Memory Drive (61) contains control electronics: specifically USB Device and Memory Controller (63) to manage Flash Memory Module (62). In U.S. Pat. No. 5,680,579, for example, each flash memory module or chip has a corresponding memory controller.

The inventors recognize, however, that hundreds to thousands of flash memory modules or chips are often used in applications such as those described in the mentioned patent. Consumer electronics applications will generally result in millions of assemblies being manufactured. When one considers that hundreds of millions of USB flash drives are manufactured each year, the cost of including a memory controller chip for each flash chip results in major costs added to the final product.

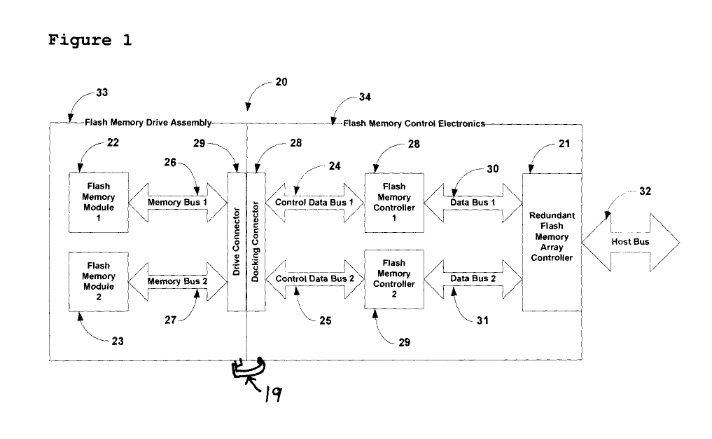

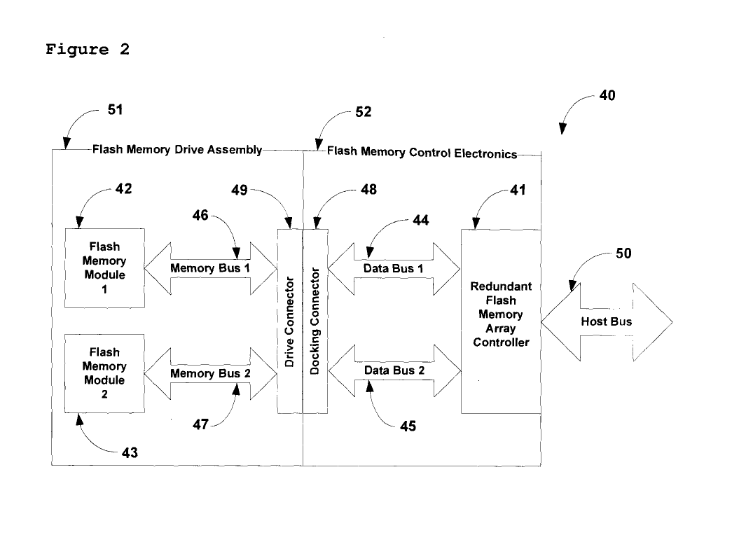

An embodiment is illustrated in FIGS. 1 and 2. FIG. 1 shows the embodiment using flash memory controllers in conjunction with the flash memory modules and FIG. 2 shows the embodiment in an embodiment where the flash memory controllers are contained within the flash memory modules themselves.

The FIG. 1 embodiment uses flash memory controllers. Flash Memory Drive Assembly (33) is made up of Drive Connector (29), Flash Memory Module 1 (22), Flash Memory Module 2 (23), Memory Bus 1 (26) and Memory bus 2 (27). Flash Memory Control Electronics (34) is made up of Docking Connector (28), Control Data Bus 1 (24), Control Data Bus 2 (25), Flash Memory Controller 1 (28), Flash Memory Controller 2 (29), Data Bus 1 (30), Data Bus 2 (31), and Redundant Flash Memory Array Controller (21) and Host Bus (32). The host bus 32 connects to the host, in operation, for example via a USB connector, external serial ATA connector, FireWire connector, IEEE 1394, PCI-x or by some other similar computer connector. Note also that Security Clip (19) maintains the physical connection between Flash Memory Drive Assembly (33) and Flash Memory Control Electronics (34). Said retainer clip prevents the two assemblies from becoming unfastened in applications where mechanical variation may be an issue.

An advantage of this architecture is that the control electronics 34 is physically separable from the memory portions 33 based on the control electronics 34 being in a first housing, and the flash memory drive assembly being in a second housing. The housings may be standardized in size, so that when coupled, their outer perimeters are substantially the same. The entire memory Drive 20 may be sold as a unit, with Drive 33 coupled to control 34. Alternatively, however, a user who already has the controller part 34 may simply purchase the memory part 33. For example, a user may purchase one control electronic device 34, and five of the memory drivers 33. The user can then used control electronics 34 with any of the different memory drives 33 by simply undocking between the connectors 28, 29, changing memory drives, and then using the new memory drive.

In the embodiment, the Drive connector and docking connector 28, 29 are snug fit connectors, intended for a docking operation. In addition, however, a clip 19 may be used to physically maintain the attachment between the units.

An unexpected advantage is that the cost may be reduced by this architecture. Once a user has the control electronics, they can easily purchase additional or updated memory elements. If the memories become inexpensive enough, they can be distributed with software or other media thereon.

The host writes the data, by transferring the write commands and data over Host Bus (32) to Flash Memory Control Electronics (34). The data is received by Redundant Flash Memory Array Controller (21). Redundant Flash Memory Array Controller (21) processes the data much the same as a RAID controller would process data, Redundant Flash Memory Array Controller (21) stripes the data, byte for byte, across Data Bus 1 (30) and Data Bus 2 (31).

In the embodiment, there are 2 flash memory modules, each of which acts like a hard disk drive. Data striped equally across 2 flash memory modules is handled like a write to a RAID array, with 2 flash elements, referred to as RAID-0 (striped with no parity). In alternate embodiments, there may be more than 2 flash memory modules and data paths, e.g., 3, 4 or 5 flash memory modules with each acting like a hard disk drive with data being distributed in a RAID-5 manner where 4 of the memory modules will be written with data and the 5^{th} used for parity data, using any of the RAID formats, for example, standardized by the Storage Network Industry Association (SNIA). Again, depending on the number of flash memory modules, RAID 3, 4, 5, or 6 may be supported.

Flash Memory Controller 1 (28) and Flash Memory Controller 2 (29) receive the processed striped data across Data Bus 1 (30) and Data Bus 2 (31). Flash memory Controller 1 (28) sends commands and data across Control Data Bus 1 (24) through Docking Connector (28) and Drive Connector (29), across Memory Bus 1 (26) to Flash Memory Module 1 (22). Flash Memory Module 1 (22) receives the commands and data from Memory Bus 1 (26) and writes the data into the memory locations or pages as specified by the commands. Flash memory Controller 2 (29) sends commands and data across Control Data Bus 2 (25) through Docking Connector (28) and Drive Connector (29), across Memory Bus 2 (27) to Flash Memory Module 2 (23). Flash Memory Module 2 (23) receives the commands and data from Memory Bus 2 (27) and writes the data into the memory locations or pages as specified by the commands.

When the host reads data, it sends read commands across Host Bus (32) to Flash Memory Control Electronics (34) The read commands are received by Redundant Flash Memory Array Controller (21). Redundant Flash Memory Array Controller (21) processes the commands and sends the equivalent of 2 read commands across Data Bus 1 (30) and Data Bus 2 (31) to Flash Memory Controller 1 (28) and Flash Memory Controller 2 (29). Flash Memory Controller 1 (28) sends read commands across Control Data Bus 1 (24) through Docking Connector (28) and Drive Connector (29), Memory Bus 1 (26) to Flash Memory Module 1 (22). Flash Memory Module 1 (22) processes the read command and sends the data specified in the command back across Memory Bus 1 (26), through Drive Connector (29) and Docking Connector (28), across Control Data bus 1 (24) to Flash Memory Controller 1 (28). Flash Memory Controller 1 (28) then sends the read data across Data Bus 1 (30) to Redundant Flash Memory Array Controller (21). Flash Memory Controller 2 (29) sends read commands across Control Data Bus 2 (25) through Docking Connector (28) and Drive Connector (29), Memory Bus 2 (27) to Flash Memory Module 2 (23). Flash Memory Module 2 (23) processes the read command and sends the data specified in the command back across Memory Bus 2 (27), through Drive Connector (29) and Docking Connector (28), across Control Data bus 2 (25) to Flash Memory Controller 2 (29). Flash Memory Controller 2 (29) then sends the read data across Data Bus 2 (31) to Redundant Flash Memory Array Controller (21). Once Redundant Flash Memory Array Controller (21) has the data it requested from both Flash Memory Controller 1 (28) and Flash Memory Controller 2 (29) it reassembles the data into a single buffer such that the data is identical to what it had previously written to Flash Memory Modules 1 (22) and Flash Memory Module 2 (23). For example, this may un-stripe the data, byte for byte, prior to sending the data on the bus. Redundant Flash Memory Array Controller (21) then sends the data across Host bus (32) to the host that had issued the read command.

Unexpected advantages come from using this architecture. For example, by dividing the information from the host into two or more parallel data paths, the throughput can be doubled or more. More hardware is necessary for this, but the hardware may not necessarily be more expensive. In general, the flash memory modules such as 22 and 23 are more expensive per megabyte for the largest modules than they are for the less large e.g. generation old modules. For example, as of today's writing, the 2 Mb modules are often less than half the cost of the 4 Mb modules. Therefore, using multiple lower capacity modules unexpectedly may reduce the cost while increasing the throughput.

Also, the hardware for dividing the data into the multiple parallel arrays may use simple off-the-shelf hardware that is conventionally available for RAID purposes.

FIG. 2 depicts another embodiment which may allow a somewhat lower cost. This embodiment takes advantage of newer generations of flash memory where the flash memory controller chip is embedded inside the actual flash memory chip or module. FIG. 2 depicts the embodiment (40) in a configuration where the embodiment has a Flash Memory Drive Assembly (51), Security Clip (19) and Flash Memory Control Electronics (52). Flash Memory Drive Assembly (51) is made up of Drive Connector (49), Flash Memory Module 1 (42), Flash Memory Module 2 (43), Memory Bus 1 (46) and Memory bus 2 (47). Flash Memory Control Electronics (52) is made up of Docking Connector (48), Data Bus 1 (44), Data Bus 2 (45), and Redundant Flash Memory Array Controller (41) and Host Bus (50). When the host is writing data to this embodiment, it transfers the write commands and data over Host bus (50) to Flash Memory Control Electronics (52). The data is received by Redundant Flash Memory Array Controller (41). Redundant Flash Memory Array Controller (41) processes the data much the same as a RAID controller would process data. Redundant Flash Memory Array Controller (41) will stripe the data byte for byte across Data Bus 1 (44) and Data Bus 2 (45). As in the first embodiment, FIG. 2 shows 2 flash memory modules, each of which acts like a hard disk drive. Data striped equally across 2 flash memory modules would be referred to as RAID-0 (striped with no parity). In alternate embodiments, there may be 3, 4 or 5 flash memory modules with each flash memory module acting like a hard disk drive with data being distributed in a RAID-5 manner where 4 of the memory modules will be written with data and the 5^{th} used for parity data. Again, depending on the number of flash memory modules, RAID 3, 4, 5, or 6 may be supported.

Redundant Flash Memory Array Controller (41) sends commands and data across Data Bus 1 (44) through Docking Connector (48) and Drive Connector (49), across Memory Bus 1 (46) to Flash Memory Module 1 (42). Flash Memory Module 1 (42) receives the commands and data from Memory Bus 1 (46) and writes the data into the memory locations or pages as specified by the commands. Redundant Flash Memory Array Controller (41) also sends commands and data across Data Bus 2 (45) through Docking Connector (48) and Drive Connector (49), across Memory Bus 2 (47) to Flash Memory Module 2 (43). Flash Memory Module 2 (43) receives the commands and data from Memory Bus 2 (47) and writes the data into the memory locations or pages as specified by the commands. When the host reads data from the FIG. 2 embodiment, it will send read commands across host bus (50) to Flash Memory Control Electronics (52). The read commands are received by Redundant Flash Memory Array Controller (41). Redundant Flash Memory Array Controller (41) processes the commands and sends the equivalent of 2 read commands across Data Bus 1 (44) and Data Bus 2 (45). Flash Memory Array Controller (41) sends read commands across Data Bus 1 (44) through Docking Connector (48) and Drive Connector (49), Memory Bus 1 (46) to Flash Memory Module 1 (42). Flash Memory Module 1 (42) processes the read command and sends the data specified in the command back across Memory Bus 1 (46), through Drive Connector (49) and Docking Connector (48), across Data bus 1 (44) to Redundant Flash Memory Array Controller (41). Redundant Flash Memory Array Controller (41) also sends read commands across Data Bus 2 (45) through Docking Connector (48) and Drive Connector (49), Memory Bus 2 (47) to Flash Memory Module 2 (43). Flash Memory Module 2 (43) processes the read command and sends the data specified in the command back across Memory Bus 2 (47), through Drive Connector (49) and Docking Connector (48), across Data bus 2 (45) to Redundant Flash Memory Array Controller (41). Once Redundant Flash Memory Array Controller (41) has the data it requested from both Flash Memory Module 1 (42) and Flash Memory Module 2 (43) it reassembles the data into a single buffer such that the data is identical to what it had previously written. Redundant Flash Memory Array Controller (41) then sends the data across Host bus (50) to the host that had issued the read command.

The embodiments results in a lower cost and fewer processing steps for operation. The embodiment allows for all of the bus control electronics to be contained within the Flash Memory Control Electronics assembly and the storage electronics contained in the drive assembly unlike current USB Flash Memory Drive configurations. This embodiment puts the Flash Memory Drive Assemblies more in the class of pure removable media and accelerates the move to drive incremental cost out of large fast flash memory assemblies. The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of controllers, connectors and memory can be used. The controller can be a hardware based device, or can be a DSP or other reprogrammable part.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. An apparatus, comprising:
a data connection;
a controller, receiving data from said data connection, said controller dividing said data from said data connection into at least two substantially parallel paths; and
at least two flash memory modules, said at least two flash memory modules respectively connected to said at least two substantially parallel paths.

2. An apparatus as in claim 1, wherein said controller is a RAID controller.

3. An apparatus as in claim 1, further comprising a first housing, housing said RAID controller, and having a docking connector thereon, and a second housing, housing said at least two memory modules, and having a second docking connector thereon which mates with said first docking connector.

4. An apparatus as in claim 3, further comprising a flash memory controller, receiving said at least two substantially parallel data paths.

5. An apparatus as in claim 4, wherein said flash memory controller is located in said first housing.

6. An apparatus as in claim 1, wherein said flash memory module includes a built-in controller.

7. An apparatus, comprising:
a first housing, having a connection to a computer, and having at least one memory control structure therein, said first housing also having a docking connector, said memory control structure controlling at least one aspect of storing data from the computer connection on to a nonvolatile memory; and
a second housing, having a drive connector that mates with said docking connector in a way that maintains a physical connection and a physical structural relation between said first and second housing, said second housing having a nonvolatile memory module therein that receives data that has been processed by said memory control structure.

8. An apparatus as in claim 7, wherein said memory control structure includes a redundant controller that divides a data stream from said computer into at least two separate data paths.

9. Apparatus as in claim 7, wherein said memory control structure includes a flash memory controller.

10. Apparatus as in claim 8, wherein said redundant controller is a RAID controller.

11. Apparatus as in claim 7, wherein said nonvolatile memory has a memory control structure as part of the memory chip.

12. A method, comprising:
receiving data to be stored in a nonvolatile memory into a housing that is physically separable and separate from a computer that produces said data;
dividing said data into at least two streams of information; and
coupling said two streams of information respectively into at least two separate nonvolatile memory modules to be stored therein.

13. A method as in claim 12, further comprising reading back information from said at least two separate nonvolatile memory modules, recombining said information from said memory modules, and outputting the recombined data to the computer.

14. A method as in claim 12, further comprising allowing separation of a first housing including the memory module from a second housing including the control structure.
